(19) United States
(12) Patent Application Publication
(10) Pub. No.: US 2025/0091775 A1
(43) Pub. Date: Mar. 20, 2025

(54) NOZZLE FOR DISPENSING ORAL CARE COMPOSITIONS AND RELATED ASSEMBLIES AND METHODS

(71) Applicant: The Procter & Gamble Company, Cincinnati, OH (US)

(72) Inventors: Tiffany Celeste HARE, West Chester, OH (US); Phillip Asa DRAKE, Mason, OH (US); Jeremy Clay CHRISTMAN, Liberty Township, OH (US)

(21) Appl. No.: 18/816,511

(22) Filed: Aug. 27, 2024

Related U.S. Application Data
(60) Provisional application No. 63/582,606, filed on Sep. 14, 2023.
(60) Provisional application No. 63/582,609, filed on Sep. 14, 2023.
(60) Provisional application No. 63/651,064, filed on May 23, 2024.

(51) Int. Cl. B65D 47/08; A45D 40/26; B65D 83/00

(52) U.S. Cl. CPC B65D 47/0804; A45D 40/26; B65D 83/771; B65D 2547/066

(57) ABSTRACT

A nozzle for dispensing an oral care composition includes an orifice having a central axis and fins partially occluding the orifice, where each of the fins has an upper surface and a lower surface. In use, the nozzle may result in a dispensed oral care composition having an increased weight compared to the same composition being dispensed from a conventional, unobstructed circular orifice. Assemblies and methods are also provided.

### TECHNICAL FIELD

The disclosure relates generally to a nozzle for dispensing an oral care composition and, more particularly, relates to a nozzles, assemblies, and methods for dispensing an oral care composition.

### BACKGROUND

Oral care compositions, such as toothpaste and/or dentifrice compositions, can be applied to the oral cavity to clean and/or maintain the aesthetics and/or health of the teeth, gums, and/or tongue. Additionally, many oral care compositions are used to deliver active ingredients directly to oral care surfaces. Using the right amount of the oral care composition ensures that you have the right amount of active ingredients to provide effective cleaning and removal of plaque, food particles, and bacteria, promoting optimal oral hygiene. For example, many toothpastes contain fluoride, which helps strengthen tooth enamel and prevent tooth decay. Using the correct amount of toothpaste ensures that you receive an effective dose of fluoride and/or the intended amount of aesthetic ingredients (e.g., flavor).

Many commercial toothpaste packages have a flexible tube to contain the toothpaste and a cylindrical nozzle. When a user squeezes the flexible tube, toothpaste is extruded through the cylindrical nozzle and dispensed in the form of a nurdle onto a toothbrush head. Users often apply less toothpaste to their brushes than the recommended dose. There is a need for devices or methods for providing a nurdle of increased weight compared to a conventional circular nozzle without requiring the user to change habits.

### SUMMARY

In an embodiment, a nozzle for dispensing an oral care composition includes an orifice having a central axis and fins partially occluding the orifice, where each of the fins has an upper surface and a lower surface. The center of the orifice may be occluded. The nozzle may comprise an on-axis extrusion area and an off-axis extrusion area. The upper surface of each of the fins may be distal of the orifice.

In an embodiment, an assembly includes a nozzle, a tube, and a cap configured to be coupled to the tube.

In an embodiment, a method of dispensing an oral care composition includes extruding the oral care composition through a nozzle, where at least a portion of the oral care composition is extruded off-axis from the central axis of the orifice.

### BRIEF DESCRIPTION OF THE DRAWINGS

While the specification concludes with the claims particularly pointing out and distinctly claiming the invention, it is believed that the present invention will be better understood from the following description taken in conjunction with the accompanying drawings in which:

FIG. 1 is a top view of an example embodiment of a nozzle.

FIG. 2 is a perspective view of the nozzle of FIG. 1.

FIG. 3 is a side view of the nozzle of FIG. 1.

FIG. 3A is a cross-sectional view of the nozzle of FIG. 1 taken along the line 3A-3A in FIG. 3.

FIG. 4 is a perspective view of an example embodiment of a nozzle.

FIG. 5 is a top view of the nozzle of FIG. 4.

FIG. 6 is a perspective view of an example embodiment of a nozzle.

FIG. 7 is a top view of the nozzle of FIG. 6.

FIG. 8 is a perspective view of an example embodiment of a flip-top style cap.

FIG. 9 is a perspective view of an example embodiment of a tube.

FIG. 10 is a perspective view of a nozzle with a circular, unobstructed orifice.

FIG. 11 is a perspective view of an example embodiment of a nozzle with five fins and no central hub.

FIG. 12 is a perspective view of an example embodiment of a nozzle with five inclined fins and no central hub.

FIG. 13 is a perspective view of an example embodiment of a nozzle with five fins and a central hub.

FIG. 14 is a perspective view of an example embodiment of a nozzle with five inclined fins and a central hub.

FIG. 15 is a perspective view of an example embodiment of a nozzle with propeller shaped fins.

FIGS. 16A-16G are photographs of toothpaste nurdles formed from various nozzles.

FIGS. 17A-17G are photographs of toothpaste nurdles formed from various nozzles.

FIGS. 18A-18G are a perspective view, top view, bottom view, left side view, right side view, front view, and rear view, respectively, of an example embodiment of a nozzle.

### DETAILED DESCRIPTION

Embodiments of the present invention are directed to a partially occluded nozzle that, in use, provides improved nurdle weight. The nozzle may also provide an improved aesthetic experience, an improved sensory experience, and improved dispersion of the dispensed oral care composition for the user. Embodiments of the present invention are also directed oral care assemblies comprising a nozzle and a tube as well as methods of making and using such an assembly.

The shape of the nozzle orifice has been discovered to impact toothpaste nurdle output in multiple ways. Modifying the way in which the oral care composition exits the tube has significant impacts on both physical nurdle and consumer sensory experience. For example, creating multiple separate strips at the orifice that join together to form the nurdle on the toothbrush head increases the surface area of the resulting nurdle. This in turn provides an aesthetic benefit by changing the nurdle shape from a simple cylinder to an aesthetic swirl. Additionally, or alternatively, shearing of the oral care composition upon dispensing to the toothbrush, immediately prior to brushing, appears to impact the sensory experience significantly in that it increases flavor display, increases foaming, and improves dispersibility. Without wishing to be bound by theory, it is believed that the shearing, pressurization, off-axis extrusion, alone or in combination, may result in an increase in nurdle weight as discussed further below. Thus, a nozzle according to an embodiment of the present invention can enhance the appearance of the nurdle, increase the size and surface area of the oral care composition that is dispensed, and positively impact the consumer experience of flavor, foamability, and dispersibility. These changes may be aesthetically pleasing and deliver an amount of the oral care composition that is closer to the recommended dose. The improvements in paste characteristics and brushing experience are due to the interaction of the oral care composition with the partially occluded orifice.

Although the following detailed description is given primarily in the context of a nozzle and tube for containing a dentifrice product, it will be understood that the nozzle or tube may be useful for containing and dispensing other oral care or personal care products where it is desirable to provide an increased amount of product, an improved sensory experience, or improved product dispersion compared to a conventional circular orifice.

The section headers below are provided for organization and convenience only.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied.

As used herein, “coupled” means “permanently coupled” or “releasably coupled.” The term “permanently coupled” is understood to refer to configurations in which a first element is secured to a second element such that the elements generally cannot be separated from one another without at least partially destroying one or both of the elements. The term “releasably coupled” is understood to refer to configurations in which a first element is secured to a second element, such that the first element and the second element can be separated with no or minimal damage to the first and second elements.

The term “oral care composition”, as used herein, includes a product, which in the ordinary course of usage, is not intentionally swallowed for purposes of systemic administration of particular therapeutic agents, but is rather retained in the oral cavity for a time sufficient to contact dental surfaces or oral tissues. Examples of oral care compositions include dentifrice, toothpaste, tooth gel, subgingival gel, emulsion, mouth rinse, mousse, foam, mouth spray, lozenge, chewable tablet, chewing gum, tooth whitening strips, floss and floss coatings, breath freshening dissolvable strips, unit-dose composition, fibrous composition, or denture care or adhesive product. The oral care composition may also be incorporated onto strips or films for direct application or attachment to oral surfaces, such as tooth whitening strips. Examples of emulsion compositions include the emulsions compositions of U.S. Pat. No. 11,147,753, jammed emulsions, such as the jammed oil-in-water emulsions of U.S. Pat. No. 11,096,874. Examples of unit-dose compositions include the unit-dose compositions of U.S. Patent Application Publication No. 2019/0343732.

The term “dentifrice composition”, as used herein, includes tooth or subgingival-paste, gel, or liquid formulations unless otherwise specified. The dentifrice composition may be a single-phase composition or may be a combination of two or more separate dentifrice compositions. The dentifrice composition may be in any desired form, such as deep striped, surface striped, multilayered, having a gel surrounding a paste, or any combination thereof. Each dentifrice composition in a dentifrice comprising two or more separate dentifrice compositions may be contained in a physically separated compartment of a dispenser and dispensed side-by-side.

“Active and other ingredients” useful herein may be categorized or described herein by their cosmetic and/or therapeutic benefit or their postulated mode of action or function. However, it is to be understood that the active and other ingredients useful herein can, in some instances, provide more than one cosmetic and/or therapeutic benefit or function or operate via more than one mode of action. Therefore, classifications herein are made for the sake of convenience and are not intended to limit an ingredient to the particularly stated function(s) or activities listed.

The term “substantially free” as used herein refers to the presence of no more than 0.05%, preferably no more than 0.01%, and more preferably no more than 0.001%, of an indicated material in a composition, by total weight of such composition.

The term “essentially free” as used herein means that the indicated material is not deliberately added to the composition, or preferably not present at analytically detectable levels. It is meant to include compositions whereby the indicated material is present only as an impurity of one of the other materials deliberately added.

The term “oral hygiene regimen” or “regimen” can be for the use of two or more separate and distinct treatment steps for oral health, e.g., toothpaste, mouth rinse, floss, toothpicks, spray, water irrigator, massager.

While compositions and methods are described herein in terms of “comprising” various components or steps, the compositions and methods can also “consist essentially of” or “consist of” the various components or steps, unless stated otherwise.

As used herein, the word “or” when used as a connector of two or more elements is meant to include the elements individually and in combination; for example, X or Y, means X or Y or both.

As used herein, the articles “a” and “an” are understood to mean one or more of the material that is claimed or described, for example, “an oral care composition” or “a bleaching agent.”

All measurements referred to herein are made at about 23° C. (i.e., room temperature) unless otherwise specified.

Several types of ranges are disclosed in relation to embodiments of the present invention. When a range of any type is disclosed or claimed, the intent is to disclose or claim individually each possible number that such a range could reasonably encompass, including end points of the range as well as any sub-ranges and combinations of sub-ranges encompassed therein.

### Nozzle

The size and shape of the nozzle helps define a user's experience in dispensing a desired toothpaste volume from the package. A nozzle according to an embodiment of the present invention may provide multiple benefits. For example, the weight of the nurdle may be increased to help deliver an optimal dose of the oral care composition to the user. The oral care composition may be formulated to provide a particular amount of active ingredients (e.g., fluoride) and aesthetic ingredients (e.g., for flavor or foaming). The increased weight of the nurdle due to use of the improved nozzle may lead to superior foaming and flavor display, which may provide an enjoyable brushing experience and leave the mouth feeling clean and refreshed compared to using a smaller-than-recommended amount of the oral care composition. The aesthetics of the nurdle may be improved with a swirled shape compared to a traditional cylindrical nurdle. The user may experience multiple differences during brushing due to the improved nurdle. Some examples include improved foamability, a sense that the oral care composition is lighter, more flavorful, and creamier, and improved dispersibility such that the amount of undispersed oral care composition is reduced at the end of the brushing event.

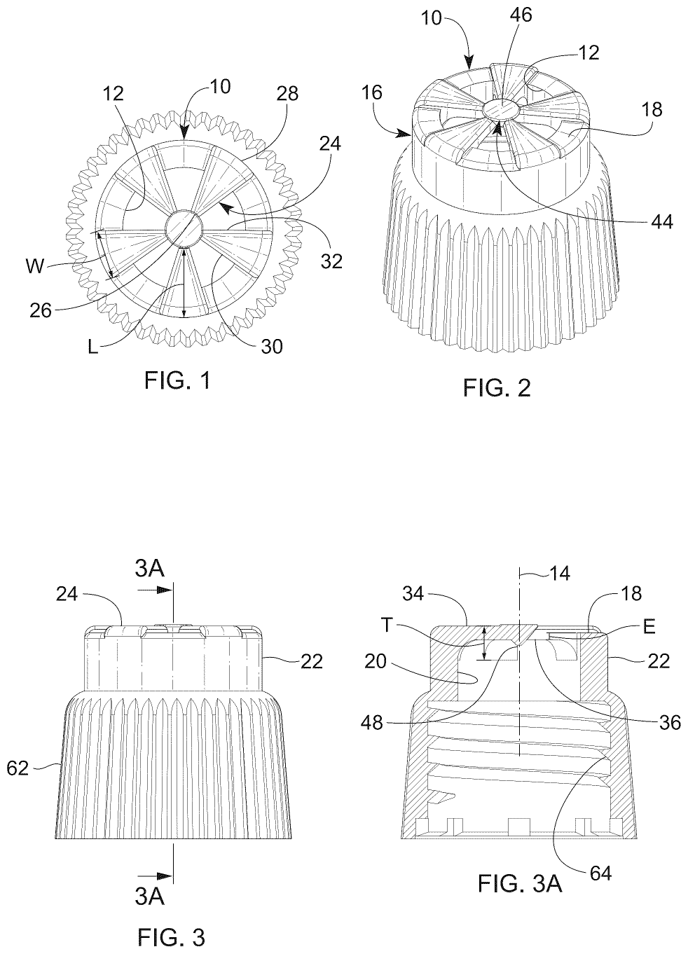

FIGS. 1-3A illustrate a nozzle 10 according to an embodiment of the present invention. In use, an oral care composition, such as a toothpaste, can be extruded through the nozzle orifice to an exterior of the nozzle 10 (e.g., onto a toothbrush) to create a nurdle. The nozzle 10 may include a nozzle orifice 12 having a central axis 14. The nozzle orifice 12 may be defined by a sidewall 16. The sidewall 16 may have a distal surface or rim 18, an inner surface 20, and an outer surface 22. The rim 18 may be on a plane orthogonal to the central axis 14 of the orifice 12. The rim 18 may be coplanar with the nozzle orifice 12. The thickness of the rim 18 can range from about 0.25 mm to about 4 mm or from about 0.5 mm to about 1.5 mm. The diameter of the orifice 12 may be about 8 mm, about 9 mm, about 10 mm, or may be from about 7 mm to about 11 mm, or from about 8 mm to about 10 mm, or from about 8.5 mm to about 10 mm.

The nozzle orifice 12 may be partially occluded, such as by one or more fins 24. The fins 24 may each extend from an inner end 26 to an outer end 28 and between a first side 30 and a second side 32. The fins 24 may also include an upper surface 34 and a lower surface 36. The fins 24 may be proximal of, distal of, or in line with the orifice 12. In an embodiment, the entire upper surface 34 of the fin 24 may be distal of the orifice 12, and the entire lower surface 36 may be proximal of the orifice 12. In an embodiment, the upper surface 34 may be flat or may be arched (see, e.g., FIG. 6). The lower surface 36 may be, for example, arched or flat (not shown). The fins 24 may be in line with each other or, for example, one or more of the fins 24 may be more proximal or more distal of another fin 24. At least a portion of the fins 24 extend over the orifice 12 to partially occlude the orifice 12. The fins 24 may extend radially outward of the orifice 12 as well. For example, the outer end 28 of the fins 24 may extend to the edge of the rim 18 of the sidewall 16. As shown in FIGS. 2 and 3A, in an embodiment, the fins 24 may extend above and below (or proximal of and distal of) the orifice 12.

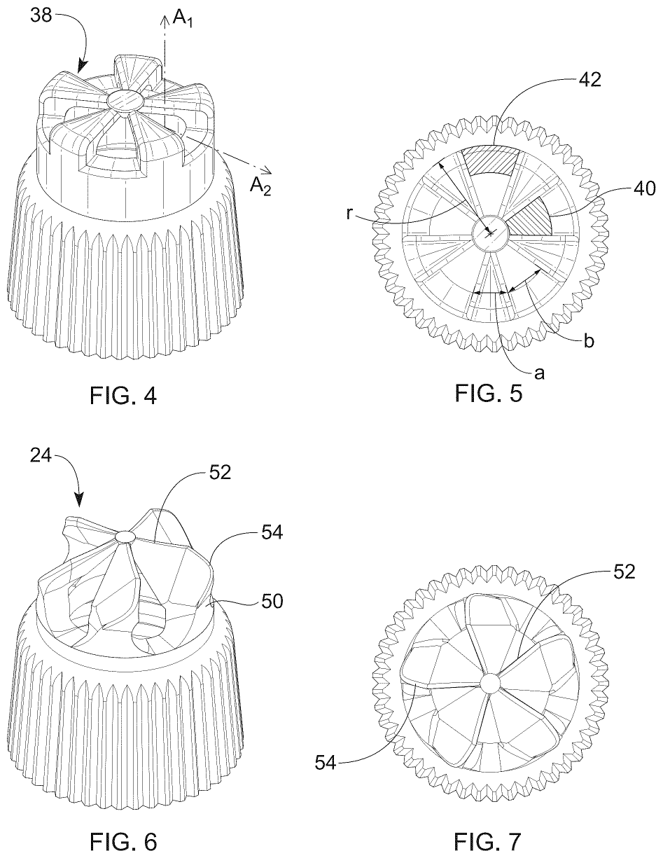

The fins 24 create openings 38 through which the oral care composition moves when being extruded through the nozzle 10. The openings 38 may be symmetrical or asymmetrical. As shown best in FIGS. 4 and 5, these openings 38 may include on-axis channels 40 and/or off-axis channels 42. The on-axis channel 40 is the space distal of the nozzle orifice 12 extending to a distal end of the fins 24. The off-axis channel 42 corresponds to the axially outside of the orifice 12 and extends to the outer ends of the fins 24. For example, in FIG. 5, the off-axis channel 42 extends from the rim 18 distally to a top of the fins 24, from the inner edge of the rim (the orifice 12) to the outer edge of the rim 18, and between the sides of the fins 24. When the oral care composition is extruded, the portion of the composition moving through the on-axis channels 40 are moving generally parallel to the central axis 14 of the orifice 12 (arrow A₁). Referring to FIG. 4, the off-axis channels 42 allow some of the extruded oral care composition to move axially away from the central axis 14 of the orifice 12 (arrow A₂). Extruding the oral care composition around the fins 24 and through the off-axis channels 42 both shears and pressurizes the flow of the oral care composition. It has been surprisingly found that the shear and pressurization may result in an increase in nurdle weight. Separately, product shear and reshaping appear to enhance and magnify flavor display, which provides an improved consumer experience when brushing with product extruded through this type of shaped orifice.

Referring to FIGS. 2 and 3A, in an embodiment, the nozzle 10 may include a hub 44 connecting the fins 24. In an embodiment, the hub 44 may be centered relative to the orifice 12 such that a longitudinal axis of the central hub 44 is coaxial with the central axis 14 of the orifice 12. The size and shape of the hub may vary. For example, an upper surface 46 of the hub 44 may be circular. The greatest diameter of the central hub 44 can range, for example, from about 0.5 mm to about 5 mm, from about 1 mm to about 4 mm, or from about 2.5 to about 3.5 mm. The central hub 44 may have a conical shape with a lower point 48, as shown best in FIG. 3A, to direct flow of the oral care composition and encourage side extrusion. In another example, the central hub may be cylindrical or have a flat lower surface. Like the fins 24, the central hub 44 may be elevated relative to the orifice 12. The elevation may also encourage side extrusion of the oral care composition when dispensed. In an example, the upper surface 46 of the central hub 44 may be distal of the orifice 12, and the point 48 or lower surface of the central hub 44 may be proximal of the orifice 12. The central hub 44 may be in the same plane or a different plane as the fins 24. In another embodiment, the fins 24 may be spaced apart such that they do not touch each other (e.g., no central hub is present).

Several parameters, including fin width, thickness, and elevation relative to the orifice, have been found to impact the weight and aesthetics of the nurdle. Without wishing to be bound by theory, it is believed that reshaping the oral care composition as it is extruded by consumers produces an increase in effective nurdle diameter, which in turn increases the dose. Given that benefits such as caries prevention, whitening, cleaning, gingivitis reduction, breath freshening, etc., may be dose-dependent, this attribute provides an advantage for the consumer. This is particularly important when using a smaller toothbrush head, such as those found on most power brushes, where the available surface area on which the product may be dispensed is limited compared to most manual brush heads.

The off-axis extrusion area and the total orifice area that is restricted can vary. The off-axis extrusion area can range from 0 mm² to about 1 cm², 0 mm² to about 25 mm², from about 0 mm² to about 5 mm², or from about 3.9 to about 16.4 mm². In an embodiment where the fins are sector or pie-piece shaped, the off-axis extrusion area may be approximated by the product of: the number of fins (n), the distance that the top of the fin protrudes distally beyond the orifice, and the approximate width of the opening between fins (b). The approximate width of the opening between fins (b) can be calculated according to the following equation:

$$b = \frac{( 2 π r - an )}{n}$$

where “r” is a radial distance from the center of the orifice to the outer circle defined by the ends of the fins, “n” is the number of fins, and “a” is the fin width at inner edge of orifice. FIG. 5 shows “r,” “a,” and “b” in an example embodiment. The off-axis extrusion area may be divided into low-pressure and high-pressure areas.

The total orifice surface area that is restricted (e.g., by the fins 24 and the optional hub 44) can range from about 10% to about 90%, from about 40% to about 60%, from 38.3% to about 58.9%, from about 44.6% to about 49.6%, from about 45% to about 50%, or about 46% to about 48% of the total orifice surface area.

The number of the fins 24 may vary. The nozzle 10 may include, without limitation, 1 fin, 2 fins, 3 fins, 4 fins, 5 fins, 6 fins, 7 fins, or more than 7 fins. The nozzle 10 may include, without limitation, from 1 to 10 fins, from 3 to 7 fins, or from 4 to 6 fins.

The length of the fins 24 may vary. The fins 24 may have the same length or may have different lengths. FIG. 1 shows the length, L, of a fin 24. In some embodiments, the length or greatest length of the fins 24 can range from about 1 mm to about 7 mm, from about 3.25 to about 4.5 mm, or from about 3.5 to about 4 mm.

The width of the fins 24 may vary. The fins 24 may have the same width or may have different widths. The width of the fins 24 may be constant or may vary along the fin 24. The variation in width of the fins may be constant or variable. For example, as shown in FIG. 1, the sides of the fins 24 are linearly tapered inward from a greatest width, W, towards the central hub 44. In another example, the sides of the fins 24 may bow outwardly or inwardly. In some embodiments, the width or greatest width of the fins 24 may be from about 0.5 mm to about 6 mm, from about 1 mm to about 5 mm, from about 3 mm to about 5 mm, from about 3.25 mm to about 4.5 mm, or from about 3.25 mm to about 4 mm.

The thickness of the fins 24 may vary. The fins 24 may have the same thickness or may have different thicknesses. The thickness of the fins 24 may be constant or may vary along the fin 24. For example, as shown in FIG. 3A, the thickness of the fins 24 decrease from a greatest thickness, T, towards the central hub 44. In some embodiments, the thickness or greatest thickness of the fins 24 can range from about 0.1 mm to about 10 mm, from about 0.25 mm to about 5 mm, from about 0.25 to about 2 mm, or from about 0.5 to about 1.5 mm.

The elevation of the fins 24 relative to the orifice 12 may vary. The elevation of the fins 24 may be measured from the lower surface 36 of the fin 24 to the rim 18 or, if a rim is not present, the distal-most edge of the orifice 12. FIG. 3A shows an elevation, E, of the fins 24. In some embodiments, the elevation or greatest elevation can range from about −5 mm to about 5 mm, from about −2 mm to +1 mm, from about −1 mm to about 0 mm, from about −0.5 to about 0 mm, from about 0 mm to about 0.5 mm. With reference to FIGS. 4 and 5, an example embodiment of a nozzle 10 is shown where the fins 24 are elevated above the nozzle orifice 12.

The shape of the fins 24 may vary. In another embodiment, the fins may have a triangular, rectangular, or curved shape or may be shaped like a fan blade or propeller. As shown in FIGS. 1 and 5, in an embodiment, the shape of the fins 24 may be a sector or pic-piece shape. The fins 24 may extend from the rim 18 over the orifice 12. The fins 24 may be coupled to the central hub 44. The fins 24 and central hub 44 may form a wagon wheel shape. In another embodiment, the fins 24 may be arched and coupled to the central hub 44 to form a dome shape (e.g., as shown in FIG. 6). In another embodiment, the fins 24 may have ends that are not coupled to another portion of the nozzle 10. In an embodiment not including a rim, the fins 24 may be coupled to the nozzle 10 adjacent an edge of the orifice 12 and extend distally of the orifice 12. The fins 24 may be inclined at an angle relative to a central axis 14 of the orifice 12 (as shown in FIGS. 12 and 14) or may be at a right angle to the central axis 14 (as shown in FIGS. 2 and 3A).

Referring to FIGS. 6 and 7, in another embodiment, the shape of the fins 24 may be similar to a curved fan blade shape. For example, the fins 24 may have a longitudinal portion 50, an axial portion 52, and a transitional portion 54 therebetween. The longitudinal portion 50 may be coupled to the rim 18 and extend distally of the rim 18. In an embodiment not including a rim, the longitudinal portion 50 may be coupled to the nozzle 10 adjacent an edge of the orifice 12 and extend distally of the orifice 12. In the illustrated embodiment, the longitudinal portion 50 does not extend over the orifice 12. In another embodiment, the longitudinal portion 50 may extend over the orifice 12.

The axial portion 52 may extend towards the central axis 14 of the orifice. In other words, the axial portion 52 may extend over and partially occlude the orifice 12. The axial portion 52 may extend to the central hub 44 if present. In an embodiment where a central hub is not present, the end of the axial portion 52 may freely hang over the orifice 12 or may join with the axial portion 52 of another fin 24. The axial portion 52 may be inclined at an angle relative to a central axis 14 of the orifice 12. The inclination angle of the axial portion 52 may vary over a length of the axial portion 52. The inclination angle may be from about 0° to about 90°, between about 0° to about 60°, between about 15° to about 90°, between about 40° to about 50°, or may be about 0° or about 45°. In another embodiment, the axial portion 52 may be at a right angle relative to the central axis 14 of the orifice 12.

The transitional portion 54 extends between the longitudinal portion 50 and the axial portion 52. The transitional portion 54 may be curved and twisted. At least a portion of the transitional portion 54 may be inclined relative to a central axis 14 of the orifice 12. In various embodiments, the transitional portion 54 may partially occlude the orifice 12 or may not occlude the orifice 12.

Where the first and second sides 30, 32 of the fins 24 are not coplanar, the first and second sides 30, 32 may define a leading edge and a trailing edge, respectively. The trailing edge at the axial portion 52 may be distal of the leading edge at the axial portion 52. When being extruded through the nozzle, the oral care composition may first contact the leading edge before the trailing edge.

The width and thickness of the longitudinal portion 50, the axial portion 52, and the transitional portion 54 may vary. For example, a thickness of the transitional portion at the trailing edge may be greater than a thickness of the transitional portion at the leading edge. The thickness of the longitudinal portion 50 may be greater than the thickness of the end of the axial portion 52. Similarly, the width of the longitudinal portion 50 may be greater than the width of the end of the axial portion 52.

### Cap

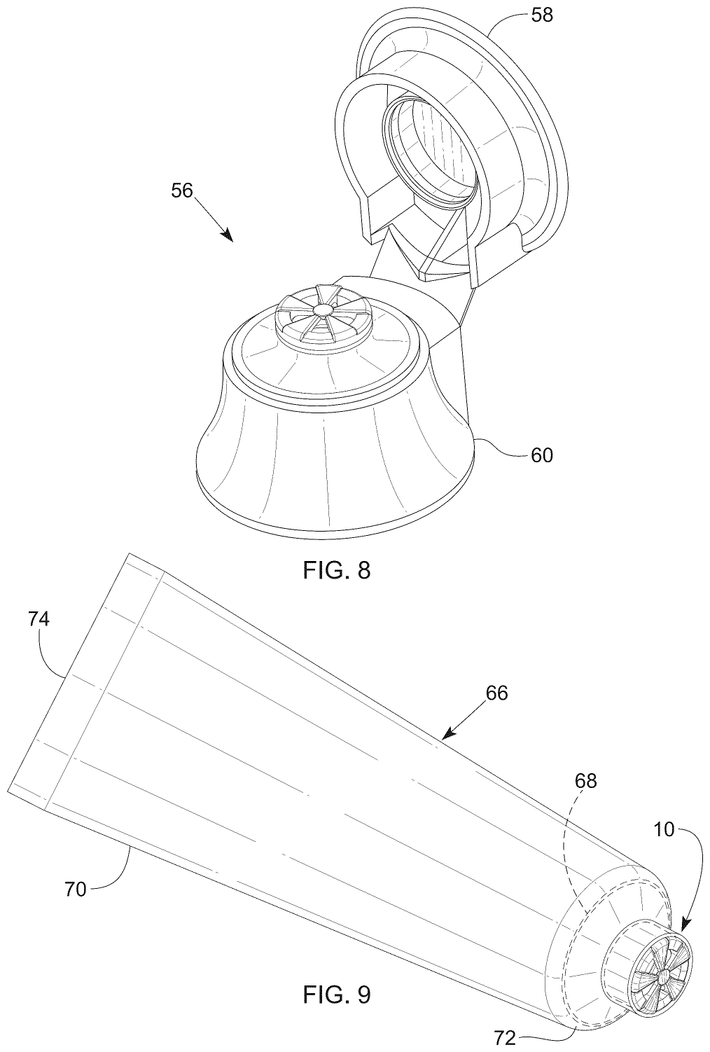

A nozzle, according to some embodiments, may be coupled to or integral with a cap. As shown in FIG. 8, in an embodiment, the cap may be a flip-top style cap 56 with a lid 58 that is hinged to the cap body 60. The cap body 60 may be configured to be releasably coupled with a container or tube.

The form of the cap may vary. The nozzle may act as a cap on a tube. The example nozzles shown in FIGS. 1-7 are depicted with a fez-style skirt extending proximally therefrom. For example, as shown in FIG. 3A, the skirt 62 may flare slightly outward from the nozzle 10 to a proximal end of the skirt 62. The outer surface of the skirt 62 may be smooth or may be textured, such as ridged. The skirt may be removably coupled with a tube, for example, using interior threads 64.

Alternatively, the nozzle may be separate from the cap. For example, the nozzle may be coupled to or integral with a tube, as discussed below. In such an embodiment, the cap may be a conventional cap, such as a screw-on style cap (e.g., a fez cap).

### Tube

An oral care assembly may include a tube, a nozzle, and a cap. FIG. 9 illustrates, according to an example embodiment, a reservoir or tube 66 and a nozzle, such as nozzle 10. The tube 66 may contain an oral care composition, such as a toothpaste. A longitudinal axis of the tube or assembly, the central axis 14 of the orifice 12, and a direction of flow of the oral care composition may be, for example, parallel or coaxial. As shown in FIG. 9, the nozzle 10 may be integral with or coupled to the tube 66. For example, if the nozzle 10 is coupled to the tube 66, the nozzle 10 may extend from an insert 68 secured inside the tube 66. In other embodiments, the nozzle 10 may be integral with or coupled to the cap (e.g., cap 56 in FIG. 8). When a cap is coupled to the tube 66 or otherwise closed, the tube 66 is sealed such that the contents of the tube are prevented from leaking under normal conditions.

The tube 66 may include a tube body 70 that is squeezable by a user to extrude the contained oral care composition through the nozzle 10. The tube body 70 may have a shoulder 72. In embodiments where the nozzle 10 is not integral with the tube 66, the tube 66 may include a tube orifice. In embodiments where the nozzle 10 is integral with the tube 66, the nozzle orifice 12 may act as the tube orifice. When the tube is squeezed, the contents of the tube pass through the tube orifice and/or the nozzle orifice 12 to an exterior of the assembly (e.g., onto a toothbrush). The tube body 70 may be sealed by a crimp seal 74 at one end, such as the end of the tube 66 that is opposite from the shoulder 72 or the tube orifice.

The tube 66 may be configured to be releasably coupled with a cap (e.g., cap 56). For example, the tube 66 and cap may include corresponding threads. The cap may include threads (e.g., threads 64 in FIG. 3A) that are configured to be releasably coupled with the threads (not shown) on the tube 66. In an embodiment, the tube 66 may include threads on an exterior surface thereof, and the cap may include threads on an interior surface thereof. In another embodiment, the cap may be configured to snap onto the tube 66.

The tube, the nozzle, and the cap may be made of the same material or be made of different materials. The tube, the nozzle, and the cap may be made of any materials known to those of skill in the art that provide adequate storage of the dentifrice or other product contained in the tube. The materials comprising the assembly should have no reaction with the components that comprise the contents, such that the contents could be rendered unsafe or otherwise unsuitable for consumer use. The materials should, of course, also be durable enough to withstand normal consumer use without leakage, tearing or breakage, etc. The materials may be able to protect the oral care composition from environmental variables (e.g., humidity or light) that may damage the composition over an expected shelf life.

For containing a dentifrice product, non-limiting examples of suitable materials from which the assembly or components thereof may be made of include polyethylenes, such as low density polyethylene (“LDPE”), linear low density polyethylene (“LLDPE”), medial density polyethylene (“MDPE”), and high density polyethylene (“HDPE”), ethylene acrylic acid (“EAA”), foils, such as aluminum foil, or any of the above materials in any combination, for example, formed as a laminate structure. The thickness of the side walls of the tube body may be, for example, from about 0.1 mm to about 0.4 mm, or about 0.3 mm. It is possible to provide thicker or thinner sidewalls, but it is believed that such would not be particularly cost-effective and would not necessarily provide additional dispensing benefits. The material may be a laminate material.

While the description herein is mainly given in the context of a tube having a single interior chamber, it is understood that the body of the present invention may be divided into multiple chambers, each chamber housing a component portion of a composition. Such embodiments are within the scope of the present invention.

### Flavor Release

Using a nozzle as described herein to extrude toothpaste may result in improved sensory characteristics. For example, the flavor release or display may be increased when using a nozzle according to an embodiment of the present invention compared to a conventional nozzle with an unobstructed circular orifice having a same diameter. The flavor release may be improved in the nurdle itself (e.g., neat toothpaste) or in a slurry. For example, while the toothpaste becomes a slurry during brushing, the flavor release may be improved compared to a toothpaste dispensed from a conventional circular orifice. The flavor release may be measured as the sum of the total ion chromatogram (TIC) peak areas of flavor components measured in the headspace.

The increase in overall flavor release (neat) from dentifrice, when extruded from a nozzle according to an embodiment of the present invention, after about 15 seconds may be, for example, at least 10%, at least 20%, at least 30%, at least 40%, at least 50%, at least 60%, or at least 70%, or in a range of about 10% to about 90% or about 15% to about 75% higher than the flavor intensity measured when the same dentifrice from the same tube is extruded through a conventional circular orifice. The increase in overall flavor release (neat) at about 30 seconds may be, for example, at least 10%, at least 20%, at least 30%, at least 40%, at least 50%, at least 60%, or at least 70%, or in a range of about 10% to about 90% or about 15% to about 85%. The increase in overall flavor release (neat) at about 60 seconds may be, for example, at least 10%, at least 20%, at least 30%, at least 40%, at least 50%, at least 60%, or at least 70%, or in a range of about 10% to about 90% or about 40% to about 50%.

The increase in overall flavor release (slurry) at about 15 seconds may be, for example, at least 10%, at least 20%, or at least 30%, or in a range of about 5% to about 40%, about 10% to about 35%, about 15% to about 30%, or about 18% to about 27%.

The effect on flavor release may also be measured for individual flavor components. The flavor components may include, without limitation, alpha-pinene, beta-pinene, limonene, eucalyptol, menthone, isomenthone, menthyl acetate, menthol, carvone, anethole, myrcene, p-cymene, and combinations thereof. Some individual components may have a greater increase in flavor release compared to others. For example, the change in flavor release of alpha-pinene up to about 60 seconds may be at least 50%, at least 100%, or at least 200%, or in a range from about 50% to about 400%. The change in flavor release of beta-pinene up to about 60 seconds may be, for example, at least 50%, at least 100%, or at least 250%, or in a range from about 50% to about 350%. In another example, the change in flavor release of limonene up to about 60 seconds may be at least 60%, at least 150%, or at least 300%, or in a range from about 60% to about 425%. For eucalyptol, the change in flavor release up to about 60 seconds may be, for example, at least 30%, at least 75%, or at least 100%, or in a range from about 30% to about 130%. The change in flavor release of menthone up to about 60 seconds may be, for example, at least 25%, at least 50%, or at least 75%, or in a range from about 25% to about 100%. In another example, the change in flavor release of isomenthone up to about 60 seconds may be at least 10%, at least 50%, or at least 70%, or in a range from about 10% to about 85%. For menthyl acetate, the change in flavor release up to about 60 seconds may be, for example, at least 10%, at least 50%, or at least 100%, or in a range from about 10% to about 120%. The change in flavor release of menthol up to about 60 seconds may be, for example, greater than 0%, at least 25%, or at least 60%, or in a range from about −5% to about 75%. In another example, the change in flavor release of carvone up to about 60 seconds may be at least 10%, at least 50%, or at least 70%, or in a range from about 10% to about 80%. For anethole, the change in flavor release up to about 60 seconds may be, for example, at least 20%, at least 50%, or at least 70%, or in a range from about 20% to about 80%. The change in flavor release up to about 30 seconds for individual compounds may be greater than 0%, at least 30%, or at least 50%, or in a range from about −7% to about 65% in a slurry.

### Oral Care Composition

The oral care composition can be in any suitable form, such as a solid, liquid, powder, paste, or combinations thereof. The oral care composition can be dentifrice, tooth gel, subgingival gel, mouth rinse, mousse, foam, mouth spray, lozenge, chewable tablet, chewing gum, tooth whitening strips, floss and floss coatings, breath freshening dissolvable strips, or denture care or adhesive product. The components of the dentifrice composition can be incorporated into a film, a strip, a foam, or a fiber-based dentifrice composition.

The oral care composition can include a variety of active and inactive ingredients, such as, for example, but not limited to a hops extract, a dicarboxylic acid, a calcium ion source, water, a fluoride ion source, a metal source such as a tin ion source and/or a zinc ion source, an antibacterial agent, a bioactive material, a potassium source, a quaternary ammonium compound, a polyphosphate, a humectant, a surfactant, a buffering agent, a monodentate ligand, a polydentate ligand, a thickening agent, an abrasive, an amino acid such as a neutral amino acid or a basic amino acid, a whitening agent, and the like, as well as any combination thereof. The oral care composition can include one or more of the active and inactive ingredients as described in U.S. Pat. No. 11,696,881 or U.S. Patent Publication No. 2021/0346259, each of which is herein incorporated by reference in its entirety.

The nozzle or assembly described herein may be particularly useful for use with an oral care composition having a viscosity range from 150,000 centipoise to 850,000 centipoise (“cP”). A method for assessing viscosity is described. The viscometer is Brookfield® viscometer, Model DV-I Prime with a Brookfield “Helipath” stand. The viscometer is placed on the Helipath stand and leveled via spirit levels. The E spindle is attached, and the viscometer is set to 2.5 RPM. Detach the spindle, zero the viscometer and install the E spindle. Then, lower the spindle until the crosspiece is partially submerged in the paste before starting the measurement. Simultaneously turn on the power switch on the viscometer and the helipath to start rotation of the spindle downward. Set a timer for 48 seconds and turn the timer on at the same time as the motor and helipath. Take a reading after the 48 seconds. The reading is in cP.

### Oral Care Composition Forms

Suitable compositions forms include emulsion compositions, such as the emulsions compositions of U.S. Pat. No. 11,147,753, which is herein incorporated by reference in its entirety, unit-dose compositions, such as the unit-dose compositions of U.S. Patent Application Publication No. 2019/0343732, which is herein incorporated by reference in its entirety, leave-on oral care compositions, jammed emulsions, such as the jammed oil-in-water emulsions of U.S. Pat. No. 11,096,874, which is herein incorporated by reference in its entirety, dentifrice compositions, mouth rinse compositions, mouthwash compositions, tooth gel, subgingival gel, mouth rinse, mousse, foam, mouth spray, lozenge, chewable tablet, chewing gum, tooth whitening strips, floss and floss coatings, breath freshening dissolvable strips, denture care products, denture adhesive products, or combinations thereof.

### Methods

The oral care compositions, as described herein, can lead to oral health benefits, such as the treatment, reduction, and/or prevention of caries, cavities, gingivitis, and/or combinations thereof and/or the whitening of teeth, removing stain from teeth, and/or preventing the accumulation of stain from teeth when applied to the oral cavity. For example, a user can dispense at least a one-inch strip or nurdle of a suitable oral care composition, as described herein, onto an oral care implement, such as a toothbrush, applicator, and/or tray, and applied to the oral cavity and/or teeth. Using a nozzle as described above, dispensing the oral care composition may include on-axis extrusion and off-axis extrusion of the oral care composition.

The user can be instructed to brush teeth thoroughly for at least 30 seconds, at least one minute, at least 90 seconds, or at least two minutes at least once, at least twice, or at least three times per day. The user can also be instructed to expectorate the oral care composition after the completion of the brush procedure.

The user can also be instructed to rinse with a mouthwash and/or mouth rinse composition after the completion of the brush procedure or instead of the brush procedure. The user can be instructed to swish the oral care composition thoroughly for at least 30 seconds, at least one minute, at least 90 seconds, or at least two minutes at least once, at least twice, or at least three times per day. The user can also be instructed to expectorate the oral care composition after the completion of the procedure.

The oral care compositions according to embodiments of the present invention can be used in the treatment, reduction, and/or prevention of caries, cavities, gingivitis, and/or combinations thereof. The oral care compositions according to embodiments of the present invention can be used to provide a whitening benefit, such as the whitening of teeth, removing stain from teeth, and/or preventing the accumulation of stain on teeth.

The oral care composition can include primary packaging, such as a tube, bottle, and/or tub. The primary package can be placed within secondary package, such as a carton, shrink wrap, or the like. Instructions for use of the oral care composition can be printed on the primary package and/or the secondary package. The scope of the method is intended to include instructions provided by a manufacturer, distributor, and/or producer of the oral care composition.

If the oral care composition is a toothpaste, the user can be instructed to dispense the toothpaste from the toothpaste tube.

The user can be instructed to apply a portion of the toothpaste onto a toothbrush. The portion of the toothpaste can be of any suitable shape, such as strip, a pea-sized amount, or various other shapes that would fit onto any mechanical and/or manual brush head. The user can be instructed to apply a strip of the toothpaste that is at least about 1 inch, at least about 0.5 inch, at least 1 inch, and/or at least 0.5 inch long to the bristles of a toothbrush, such as soft-bristled toothbrush.

The user can be instructed to apply pea-sized or grain of rice-sized portion of the toothpaste to the bristles of a toothbrush, such as in the case of use by children of less than 6 years old and/or less than 2 years old.

The user can be instructed to brush their teeth for at least about 30 seconds, at least about 1 minute, at least about 90 seconds, at least about 2 minutes, at least 30 seconds, at least 1 minute, at least 90 seconds, and/or at least 2 minutes.

The user can be instructed to brush their teeth thoroughly and/or as directed by a physician and/or dentist.

The user can be instructed to brush their teeth after each meal. The user can be instructed to brush their teeth at least once per day, at least twice per day, and/or at least three times per day. The user can be instructed to brush their teeth no more than three times a day, such as to prevent Sn staining. The user can be instructed to brush their teeth in the morning and/or in the evening prior to sleeping.

The user can be instructed to not swallow the toothpaste composition due to the inclusion of ingredients that are not suitable for ingestion, such as fluoride. However, in the case of an oral care composition comprising hops, but free of fluoride, the user may not need to be instructed to not swallow the toothpaste. The user may be instructed to expectorate (or spit out) the toothpaste composition after the cessation of the brushing cycle.

The user can be instructed to use the mouth rinse at least once a day, at least twice a day, and/or at least three times a day.

The user can be instructed to use the mouth rinse composition after the use of toothpaste and/or floss.

The user can be instructed to swish a portion of rinse in the oral cavity, such as between the teeth, for a period of time. The user can be instructed to vigorously swish a portion of the rinse.

The user can be instructed to use be from about 5 mL to about 50 mL, from about 10 mL to about 40 mL, 10 mL, 20 mL, 25 mL, 30 mL, 40 mL, 2 teaspoonfuls, and/or 4 teaspoonfuls of mouth rinse.

The user can be instructed to swish the mouth rinse for at least about 30 seconds, at least about 1 minute, at least about 90 seconds, at least about 2 minutes, at least 30 seconds, at least 1 minute, at least 90 seconds, and/or at least 2 minutes.

The user can be instructed to not swallow the mouth rinse composition due to the inclusion of ingredients that are not suitable for ingestion, such as fluoride. However, in the case of an oral care composition comprising hops, but free of fluoride, the user may not need to be instructed to not swallow the mouth rinse. The user may be instructed to expectorate (or spit out) the mouth rinse composition after the cessation of the rinse cycle.

The usage instructions for the oral care composition, such as for a toothpaste composition and/or a mouth rinse composition, can vary based on age. For example, adults and children that are at least 6 or at least 2 can have one usage instruction while children under 6 or under 2 can have a second usage instruction.

Additionally, the oral care composition, as described herein, can be used to reduce the number and/or intensity of white spots on teeth, which can be attributable to caries presence within the oral cavity. Or the oral care composition, as described herein, can be used to reduce the redness, puffiness, tenderness, and/or swollenness of gums at the gumline immediately adjacent the surfaces of the teeth, which can be attributable to gingivitis presence within the oral cavity.

### Combinations

A. A nozzle for dispensing an oral care composition comprising:
   an orifice having a central axis; and
   fins partially occluding the orifice, wherein each of the fins has an upper surface and a lower surface.
B. The nozzle as disclosed in A, wherein a center of the orifice is occluded.
C. The nozzle as disclosed in A or B, further comprising a central hub, wherein the fins are coupled to the central hub.
D. The nozzle as disclosed in A, wherein the fins are not in contact with a central hub.
E. The nozzle as disclosed in any one of A-D, wherein the upper surface of each of the fins is distal of the orifice.
F. The nozzle as disclosed in any one of A-E, wherein the lower surface of each of the fins is proximal of the orifice.
G. The nozzle as disclosed in any one of A-E, wherein the lower surface of each of the fins is distal of the orifice.
H. The nozzle as disclosed in any one of A-G, further comprising an on-axis extrusion area and an off-axis extrusion area.
I. The nozzle as disclosed in any one of A-H, further comprising a sidewall defining the orifice, wherein the sidewall comprises an inner wall, a rim, and an outer wall.
J. The nozzle as disclosed in I, wherein each of the fins further comprise an outer end that extends to the outer wall of the sidewall.
K. The nozzle as disclosed in I, wherein the lower surface of each of the fins extends from the inner surface of the sidewall.
L. The nozzle as disclosed in any one of A-K, wherein the fins are inclined relative to the central axis of the orifice.
M. The nozzle as disclosed in any one of A-L, wherein a distance between the lower surface of the fins and the orifice varies over a length of the fins.
N. The nozzle as disclosed in any one of A-M, wherein a shape of the fins is a sector.
O. The nozzle as disclosed in any one of A-N, wherein each of the fins comprises a longitudinal portion extending distally of the orifice, an axial portion extending over the orifice, and a transitional portion coupling the longitudinal portion and the axial portion.
P. An assembly comprising:
   the nozzle as disclosed in any one of A-O;
   a tube; and
   a cap configured to be coupled to the tube.
Q. The assembly as disclosed in P, wherein the nozzle is integral with the cap.
R. The assembly as disclosed in P, wherein the nozzle is integral with the tube.
S. The assembly as disclosed in P, wherein the nozzle is coupled to the tube.
T. The assembly as disclosed in S, wherein an insert comprises the nozzle, and the insert is positioned in the tube.
U. The assembly as disclosed in P, wherein the cap screws onto the tube.
V. The assembly as disclosed in P, wherein the cap snaps onto the tube.
W. A method of dispensing an oral care composition comprising:
   extruding the oral care composition through a nozzle as disclosed in any one of A-O, wherein at least a portion of the oral care composition is extruded off-axis from the central axis of the orifice.
X. The method as disclosed in W, wherein an assembly comprises the nozzle and a tube containing the oral care composition, and extruding the oral care composition comprises applying pressure to the tube.

### Examples

The invention is further illustrated by the following examples, which are not to be construed in any way as imposing limitations to the scope of this invention. Various other aspects, modifications, and equivalents thereof which, after reading the description herein, may suggest themselves to one of ordinary skill in the art without departing from the spirit of the present invention or the scope of the appended claims.

### Gravimetric Assessment Procedure

1. Tare a manual toothbrush (Anchor, Tuft white toothbrush p/n 000-10923/A) on an analytical balance capable of recording to at least four decimal places (e.g., Mettler Toledo XS205).
2. Squeeze a full nurdle of Crest ProHealth onto the brush, from end to end of brush head, using consistent time and pressure to dispense.
3. Place the full brush back on the balance and record the weight of the nurdle in grams.
4. Repeat gravimetric assessment in triplicate for each prototype. Calculate the mean and the standard deviation for each set of replicates.

### Gravimetric Assessment Discussion

The amount of a material dispensed through an orifice is controlled by the following dependent variables: dispensing pressure (increase in pressure increases amount dispensed), dispensing time (increase in time increases amount dispensed), and orifice diameter (increase in diameter increases amount dispensed), and the following independent variables: material viscosity and material thixotropy (shear thinning properties of the material, where decrease in viscosity or increase in thixotropy increases amount dispensed when all other variables are held constant). Various Inventive Nozzles described below were compared to a Control Nozzle, which has a diameter of 9.0 mm and is unobstructed. The Inventive Nozzles used in this assessment had fins that were not inclined (i.e., 0° angle). The unexpected result of the partially occluded orifice described herein is that, by decreasing the effective orifice diameter, while including design parameters that direct the flow of material off-axis, the amount of pressure required to dispense the material is increased, thereby increasing the amount of material dispensed.

The variables are described below. Unless otherwise described in TABLES 1-7, the Inventive Nozzles 1A-7E each had the features shown in TABLE A. The orifice diameter is defined as the width of the orifice from one side of the rim to the other as measured through the center.

TABLE A
Features of Inventive Nozzles 1A-7E

| | |
|---|---|
| Fin width (mm) | 3.75 |
| Fin elevation (mm) | −0.5 |
| Disk diameter (mm) | 3.0 |
| *Shape orifice diameter (mm) | 9.0 |
| *Nominal orifice diameter (mm) | 9.0 |
| # Of fins | 5 |
| % Restriction | 47.1 |

TABLE 1 shows the results for Inventive Nozzles 1A-1F that had varying fin width and, as a result, varying percent restriction. All other variables were held constant. The results in TABLE 1 show that all of Inventive Nozzles 1A-1F passed except for Inventive Nozzle 1F on a manual toothbrush.

TABLE 1
Gravimetric Assessment for Varying Fin Width

| Inventive Nozzle | 1A | 1B | 1C | 1D | 1E | 1F |
|---|---|---|---|---|---|---|
| Fin width (mm) | 3.25 | 3.50 | 3.75 | 4.00 | 4.25 | 4.50 |
| % Restriction | 42.1 | 44.6 | 47.1 | 49.6 | 52.1 | 54.5 |

Manual Toothbrush

| | | | | | | |
|---|---|---|---|---|---|---|
| Mean Value (g) | 2.711 | 2.699 | 2.499 | 2.320 | 2.460 | 1.732 |
| Vs. Control | 0.0484 | 0.0545 | 0.2825 | 0.7566 | 0.3646 | 0.0252 |
| (p-value) | | | | | | |
| Vs. Control | PASS | PASS | PASS | PASS | PASS | FAIL |

Power Toothbrush

| | | | | | | |
|---|---|---|---|---|---|---|
| Mean Value (g) | 0.9485 | 0.9865 | 0.8991 | 0.9418 | 0.8738 | 0.9409 |
| Vs. Control | 0.0003 | <0.0001 | 0.0018 | 0.0003 | 0.0045 | 0.0003 |
| (p-value) | | | | | | |
| Vs. Control | PASS | PASS | PASS | PASS | PASS | PASS |

TABLE 2 shows the results for Inventive Nozzles 2A-2G that had varying fin elevation. All other variables were held constant. The results in TABLE 2 show that all of Inventive Nozzles 2A-2G passed for both manual and power toothbrushes.

TABLE 2
Gravimetric Assessment for Varying Fin Elevation

| Inventive Nozzle | 2A | 2B | 2C | 2D | 2E | 2F | 2G |
|---|---|---|---|---|---|---|---|
| Fin elevation (mm) | −2.00 | −1.00 | −0.25 | −0.50 | 0.00 | 0.50 | 1.00 |

Manual Toothbrush

| | | | | | | | |
|---|---|---|---|---|---|---|---|
| Mean Value (g) | 2.412 | 2.416 | 2.727 | 2.499 | 2.742 | 3.501 | 4.331 |
| Vs. Control | 0.4855 | 0.4759 | 0.0412 | 0.2825 | 0.0356 | * | * |
| (p-value) | | | | | | | |
| Vs. Control | PASS | PASS | PASS | PASS | PASS | PASS | PASS |

Power Toothbrush

| | | | | | | | |
|---|---|---|---|---|---|---|---|
| Mean Value (g) | 0.7548 | 0.6711 | 0.9946 | 0.8991 | 1.064 | 1.086 | 1.071 |
| Vs. Control | 0.1568 | 0.7242 | * | 0.0018 | * | * | * |
| (p-value) | | | | | | | |
| Vs. Control | PASS | PASS | PASS | PASS | PASS | PASS | PASS |

* <0.0001

TABLE 3 shows the results for Inventive Nozzles 3A-3D that had varying central hub diameter and, as a result, varying percent restriction. All other variables were held constant. The results in TABLE 3 show that all of Inventive Nozzles 3A-3D passed for both manual and power toothbrushes.

TABLE 3
Gravimetric Assessment for Varying Diameter of the Central Hub

| Inventive Nozzle | 3A | 3B | 3C | 3D |
|---|---|---|---|---|
| Central Hub | 1.0 | 2.0 | 3.0 | 4.0 |
| Diameter (mm) | | | | |
| % Restriction | 44.9 | 46.0 | 47.1 | 48.3 |

Manual Toothbrush

| | | | | |
|---|---|---|---|---|
| Mean Value (g) | 2.825 | 2.424 | 2.499 | 2.477 |
| Vs. Control (p-value) | 0.0146 | 0.4539 | 0.2825 | 0.3267 |
| Vs. Control | PASS | PASS | PASS | PASS |

Power Toothbrush

| | | | | |
|---|---|---|---|---|
| Mean Value (g) | 0.9363 | 0.8651 | 0.8991 | 0.9391 |
| Vs. Control (p-value) | 0.0004 | 0.0061 | 0.0018 | 0.0004 |
| Vs. Control | PASS | PASS | PASS | PASS |

TABLE 4 shows the results for Inventive Nozzles 4A-4C that had varying shape orifice diameter and, as a result, varying percent restriction. All other variables were held constant. The results in TABLE 4 show that Inventive Nozzles 4A-4C passed except for Inventive Nozzle 4A on the manual toothbrush.

TABLE 4
Gravimetric Assessment for Varying Diameter of an Obstructed Orifice

| Inventive Nozzle | 4A | 4B | 4C |
|---|---|---|---|
| Orifice Diameter (mm) | 8.0 | 9.0 | 10.0 |
| % Restriction | 58.9 | 47.1 | 38.7 |

Manual Toothbrush

| | | | |
|---|---|---|---|
| Mean Value (g | 1.957 | 2.499 | 2.531 |
| Vs. Control (p-value) | 0.1958 | 0.2825 | 0.2257 |
| Vs. Control | PASS | PASS | PASS |

Power Toothbrush

| | | | |
|---|---|---|---|
| Mean Value (g) | 0.9253 | 0.8991 | 0.8772 |
| Vs. Control (p-value) | 0.0006 | 0.0018 | 0.0040 |
| Vs. Control | PASS | PASS | PASS |

TABLE 5 shows the results for Inventive Nozzles 5A-5C that had varying nominal orifice diameter. All other variables were held constant. The percent restriction for each of Inventive Nozzles 5A-5C was 0% (i.e., the orifice was unobstructed). The results in TABLE 5 show that Inventive Nozzle 5A failed for both a manual and power toothbrush.

TABLE 5
Gravimetric Assessment for Varying Diameter
of an Unobstructed Orifice

| Inventive Nozzle | 5A | 5B | 5C |
|---|---|---|---|
| Orifice Diameter (mm) | 8.2 | 9.0 | 10.0 |

Manual Toothbrush

| | | | |
|---|---|---|---|
| Mean Value (g | 1.815 | 2.2535 | 2.370 |
| Vs. Control (p-value) | 0.0584 | control | 0.6089 |
| Vs. Control | PASS | PASS | PASS |

Power Toothbrush

| | | | |
|---|---|---|---|
| Mean Value (g) | 0.5171 | 0.6437 | 0.7984 |
| Vs. Control (p-value) | 0.1078 | control | 0.0508 |
| Vs. Control | PASS | PASS | PASS |

TABLE 6 shows the results for Inventive Nozzles 6A-6C that had a varying number of fins and, as a result, varying percent restriction. All other variables were held constant. The results in TABLE 6 show that Inventive Nozzles 6A-6C passed except for Inventive Nozzle 6A on a manual toothbrush.

TABLE 6
Gravimetric Assessment for Varying Number of Fins

| Inventive Nozzle | 6A | 6B | 6C |
|---|---|---|---|
| # Of fins | 4 | 5 | 6 |
| % Restriction | 38.3 | 47.1 | 55.9 |

Manual Toothbrush

| | | | |
|---|---|---|---|
| Mean Value (g | 1.404 | 2.499 | 2.226 |
| Vs. Control (p-value) | 0.0004 | 0.2825 | 0.9028 |
| Vs. Control | FAIL | PASS | PASS |

Power Toothbrush

| | | | |
|---|---|---|---|
| Mean Value (g) | 0.9061 | 0.8991 | 0.7251 |
| Vs. Control (p-value) | 0.0014 | 0.0018 | 0.2973 |
| Vs. Control | PASS | PASS | PASS |

TABLE 7 shows the results for Inventive Nozzles 7A-7E that had varying percent restriction and varying number of fins. All other variables were held constant. The results in TABLE 7 show that all of Inventive Nozzles 7A-7E except for Inventive Nozzle 7A on a manual toothbrush.

TABLE 7
Gravimetric Assessment for Varying Percent Restriction

| Inventive | | | | | |
|---|---|---|---|---|---|
| Nozzle | 7A | 7B | 7C | 7D | 7E |
| % Restriction | 38.3 | 47.1 | 47.1 | 47.1 | 55.9 |
| # of Fins | 4 | 4 | 5 | 6 | 6 |

Manual Toothbrush

| | | | | | |
|---|---|---|---|---|---|
| Mean Value (g) | 1.404 | 1.671 | 2.499 | 2.239 | 2.226 |
| Vs. Control (p- | 0.0004 | 0.0130 | 0.2825 | 0.9499 | 0.9028 |
| value) | | | | | |
| Vs. Control | FAIL | FAIL | PASS | PASS | PASS |

Power Toothbrush

| | | | | | |
|---|---|---|---|---|---|
| Mean Value (g) | 0.9061 | 0.9258 | 0.8991 | 0.9477 | 0.7251 |
| Vs. Control (p- | 0.0014 | 0.0006 | 0.0018 | 0.0003 | 0.2973 |
| value) | | | | | |
| Vs. Control | PASS | PASS | PASS | PASS | PASS |

Additionally, a fez cap and a flip-top style cap were tested. The properties of both style caps are the same as in TABLE A. All other variables were held constant. Both cap styles passed for both manual and power toothbrush heads.

### Nurdle Appearance Assessment Procedure

1. Squeeze a full nurdle of paste onto either a manual or power brush head by dispensing along the entire length of the brush head.
2. Capture an image of the resultant nurdle and assess for the following:
   a. Ability of strips to stay cohesive in one nurdle without splitting apart
   b. Ability of nurdle (and all strips) to remain adhered to the brush head
   c. Nurdle appears compact and is not overflowing the brush head
   d. Nurdle has a pleasant appearance, is smooth and strips do not start or stop too abruptly.
A sample was considered to pass if all conditions of 2(a)-(d) were met.

### Nurdle Aesthetic Assessment Discussion

The effect of nozzle design on the aesthetics of nurdles were evaluated. The Inventive Nozzles 1A-7E discussed above were compared to the Control Nozzle, which has a diameter of 9.0 mm and is unobstructed. The unexpected result of splitting the single cylindrical nurdle into multiple strips results in a swirled nurdle that has distinct strips and yet is still cohesive and remains adhered to the brush head. This nurdle appearance is pleasing to the eye and has the added benefit of increased surface area which further enhances the aesthetics of the paste experience.

TABLE 8 shows the results for Inventive Nozzles 1A-1F that had varying fin width. All other variables were held constant. The results in TABLE 8 show that all of Inventive Nozzles 1A-1F passed except for Inventive Nozzle 1E on a manual toothbrush.

TABLE 8
Aesthetic Assessment for Varying Fin Width

| | | | | | | |
|---|---|---|---|---|---|---|
| Inventive Nozzle | 1A | 1B | 1C | 1D | 1E | 1F |
| Fin width (mm) | 3.25 | 3.50 | 3.75 | 4.00 | 4.25 | 4.50 |
| Manual Toothbrush | PASS | PASS | PASS | PASS | FAIL | PASS |
| Power Toothbrush | PASS | PASS | PASS | PASS | PASS | PASS |

TABLE 9 shows the results for Inventive Nozzles 2A-2G that had varying fin elevation. All other variables were held constant. The results in TABLE 9 show that all of Inventive Nozzles 2A-2E passed for both manual and power toothbrushes, while Inventive Nozzles 2F and 2G failed for both manual and power toothbrushes.

TABLE 9
Aesthetic Assessment for Varying Fin Elevation

| | | | | | | | |
|---|---|---|---|---|---|---|---|
| Inventive Nozzle | 2A | 2B | 2C | 2D | 2E | 2F | 2G |
| Fin elevation (mm) | −2.00 | −1.00 | −0.25 | −0.50 | 0.00 | 0.50 | 1.00 |
| Manual Toothbrush | PASS | PASS | PASS | PASS | PASS | FAIL | FAIL |
| Power Toothbrush | PASS | PASS | PASS | PASS | PASS | FAIL | FAIL |

TABLE 10 shows the results for Inventive Nozzles 3A-3D that had varying central hub diameter and, as a result, varying percent restriction. All other variables were held constant. The results in TABLE 10 show that all of Inventive Nozzles 3A-3D passed for both manual and power toothbrushes.

TABLE 10
Aesthetic Assessment for Varying Hub Diameter

| Inventive Nozzle | 3A | 3B | 3C | 3D |
|---|---|---|---|---|
| Hub diameter (mm) | 1.0 | 2.0 | 3.0 | 4.0 |
| Manual Toothbrush | PASS | PASS | PASS | PASS |
| Power Toothbrush | PASS | PASS | PASS | PASS |

TABLE 11 shows the results for Inventive Nozzles 4A-4C that had varying shape orifice diameter and, as a result, varying percent restriction. All other variables were held constant. The results in TABLE 11 show that Inventive Nozzles 4A-4C passed except for Inventive Nozzle 4A on the manual toothbrush.

TABLE 11
Aesthetic Assessment for Varying Shape Orifice Diameter

| Inventive Nozzle | 4A | 4B | 4C |
|---|---|---|---|
| Shape orifice diameter (mm) | 8.0 | 9.0 | 10.0 |
| Manual Toothbrush | FAIL | PASS | PASS |
| Power Toothbrush | PASS | PASS | PASS |

TABLE 12 shows the results for Inventive Nozzles 5A-5C that had varying nominal orifice diameter. All other variables were held constant. The results in TABLE 12 show that Inventive Nozzles 5A-5C all passed for both a manual and power toothbrush.

TABLE 12
Aesthetic Assessment for Varying Nominal Orifice Diameter

| Inventive Nozzle | 5A | 5B | 5C |
|---|---|---|---|
| Nominal orifice diameter (mm) | 8.2 | 9.0 | 10.0 |
| Manual Toothbrush | PASS | PASS | PASS |
| Power Toothbrush | PASS | PASS | PASS |

TABLE 13 shows the results for Inventive Nozzles 6A-6C that had a varying number of fins and, as a result, varying percent restriction. All other variables were held constant. The results in TABLE 13 show that Inventive Nozzle 6B passed for both manual and power toothbrushes, while Inventive Nozzle 6A failed for both. Inventive Nozzle 6C passed on a power toothbrush but failed on the manual toothbrush.

TABLE 13
Aesthetic Assessment for Varying Number of Fins

| Inventive Nozzle | 6A | 6B | 6C |
|---|---|---|---|
| # Of fins | 4 | 5 | 6 |
| Manual Toothbrush | FAIL | PASS | FAIL |
| Power Toothbrush | FAIL | PASS | PASS |

TABLE 14 shows the results for Inventive Nozzles 7A-7E that had varying percent restriction and varying number of fins. All other variables were held constant. The results in TABLE 14 show that all of Inventive Nozzles 7A and 7C-7E passed on both manual and power toothbrushes, while Inventive Nozzle 7B failed for both.

TABLE 14
Aesthetic Assessment for Varying Percent Restriction

| Inventive Nozzle | 7A | 7B | 7C | 7D | 7E |
|---|---|---|---|---|---|
| % Restriction | 38.3 | 47.1 | 47.1 | 47.1 | 55.9 |
| Manual Toothbrush | PASS | FAIL | PASS | PASS | PASS |
| Power Toothbrush | PASS | FAIL | PASS | PASS | PASS |

Additionally, the fez cap and flip-top style cap both passed the aesthetic assessment for both manual and power toothbrushes. All other variables were held constant.

### Combined Gravimetric and Aesthetic Assessment

The above results were combined below to show whether a given Inventive Nozzle passed for both the gravimetric and aesthetic assessment.

TABLE 15 shows the results for Inventive Nozzles 1A-1F that had varying fin width. The results in TABLE 15 show that Inventive Nozzles 1A-1D passed on a manual toothbrush, and all of all of Inventive Nozzles 1A-1F passed on a power toothbrush.

TABLE 15
Combined Assessment for Varying Fin Width

| | | | | | | |
|---|---|---|---|---|---|---|
| Example | 1A | 1B | 1C | 1D | 1E | 1F |
| Fin width (mm) | 3.25 | 3.50 | 3.75 | 4.00 | 4.25 | 4.50 |
| Manual Toothbrush | PASS | PASS | PASS | PASS | FAIL (A) | FAIL (G) |
| Power Toothbrush | PASS | PASS | PASS | PASS | PASS | PASS |

(A) = Aesthetic Only (G) = Gravimetric Only

TABLE 16 shows the results for Inventive Nozzles 2A-2G that had varying fin elevation. The results in TABLE 16 show that all of Inventive Nozzles 2A-2E passed for both manual and power toothbrushes, while Inventive Nozzles 2F and 2G failed for both manual and power toothbrushes.

TABLE 16
Combined Assessment for Varying Fin Elevation

| | | | | | | | |
|---|---|---|---|---|---|---|---|
| Example | 2A | 2B | 2C | 2D | 2E | 2F | 2G |
| Fin elevation (mm) | −2.00 | −1.00 | −0.25 | −0.50 | 0.00 | 0.50 | 1.00 |
| Manual Toothbrush | PASS | PASS | PASS | PASS | PASS | FAIL | FAIL |
| | | | | | | (A) | (A) |
| Power Toothbrush | PASS | PASS | PASS | PASS | PASS | FAIL | FAIL |
| | | | | | | (A) | (A) |

TABLE 17 shows the results for Inventive Nozzles 3A-3D that had varying central hub diameter and, as a result, varying percent restriction. The results in TABLE 17 show that all of Inventive Nozzles 3A-3D passed for both manual and power toothbrushes.

TABLE 17
Combined Assessment for Varying Hub Diameter

| Example | 3A | 3B | 3C | 3D |
|---|---|---|---|---|
| Hub diameter (mm) | 1.0 | 2.0 | 3.0 | 4.0 |
| Manual Toothbrush | PASS | PASS | PASS | PASS |
| Power Toothbrush | PASS | PASS | PASS | PASS |

TABLE 18 shows the results for Inventive Nozzles 4A-4C that had varying shape orifice diameter and, as a result, varying percent restriction. The results in TABLE 18 show that Inventive Nozzles 4A-4C passed except for Inventive Nozzle 4A on the manual toothbrush.

TABLE 18
Combined Assessment for Varying Shape Orifice Diameter

| Example | 4A | 4B | 4C |
|---|---|---|---|
| Shape orifice diameter (mm) | 8.0 | 9.0 | 10.0 |
| Manual Toothbrush | FAIL | PASS | PASS |
| Power Toothbrush | PASS | PASS | PASS |

TABLE 19 shows the results for Inventive Nozzles 5A-5C that had varying nominal orifice diameter. The results in TABLE 19 show that Inventive Nozzles 5B and 5C all passed for both a manual and power toothbrush, while Inventive Nozzle 5A failed for both.

TABLE 19
Combined Assessment for Varying Nominal Orifice Diameter

| Example | 5A | 5B | 5C |
|---|---|---|---|
| Nominal orifice diameter (mm) | 8.2 | 9.0 | 10.0 |
| Manual Toothbrush | FAIL (G) | PASS | PASS |
| Power Toothbrush | FAIL (G) | PASS | PASS |

TABLE 20 shows the results for Inventive Nozzles 6A-6C that had a varying number of fins and, as a result, varying percent restriction. The results in TABLE 20 show that Inventive Nozzle 6B passed for both manual and power toothbrushes, while Inventive Nozzle 6A failed for both. Inventive Nozzle 6C passed on a power toothbrush but failed on the manual toothbrush.

TABLE 20
Combined Assessment for Varying Number of Fins

| Example | 6A | 6B | 6C |
|---|---|---|---|
| # Of fins | 4 | 5 | 6 |
| Manual Toothbrush | FAIL | PASS | FAIL (A) |
| Power Toothbrush | FAIL (A) | PASS | PASS |

TABLE 21 shows the results for Inventive Nozzles 7A-7E that had varying percent restriction and varying number of fins. The results in TABLE 21 show that Inventive Nozzles 7C and 7D passed on both manual and power toothbrushes, while Inventive Nozzle 7B failed for both. Inventive Nozzles 7A and 7E both passed on power toothbrush but failed on manual toothbrush.

TABLE 21
Combined Assessment for Varying Percent Restriction

| Example | 7A | 7B | 7C | 7D | 7E |
|---|---|---|---|---|---|
| % Restriction | 38.3 | 47.1 | 47.1 | 47.1 | 55.9 |
| Manual Toothbrush | FAIL (G) | FAIL (A) | PASS | PASS | FAIL (A) |
| Power Toothbrush | PASS | FAIL (A) | PASS | PASS | PASS |

### Gravimetric Assessment for Varying Fin Configurations

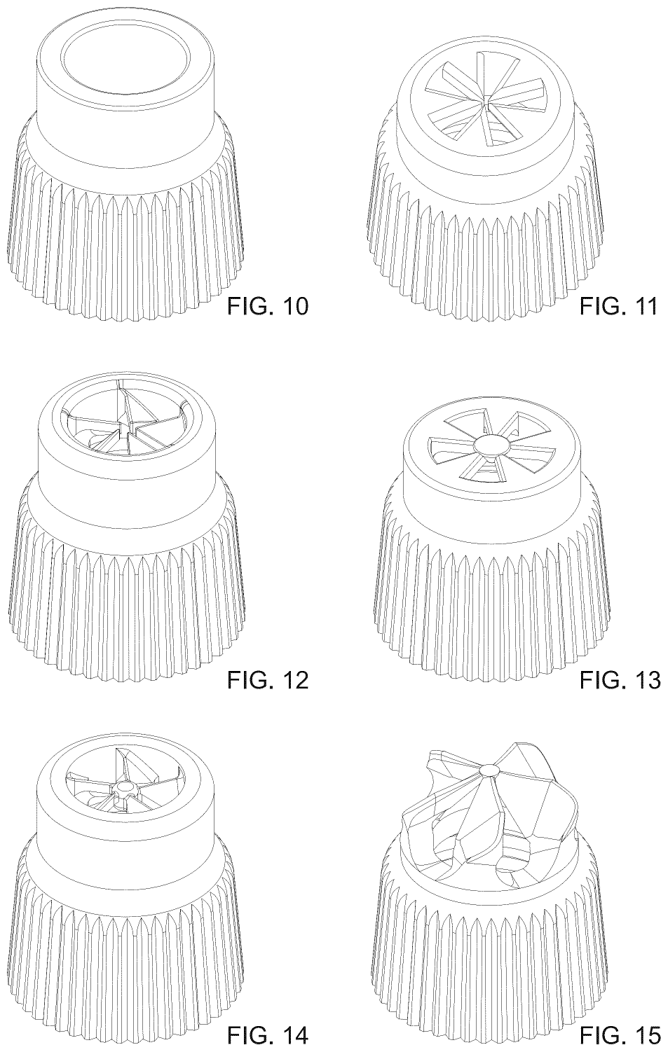

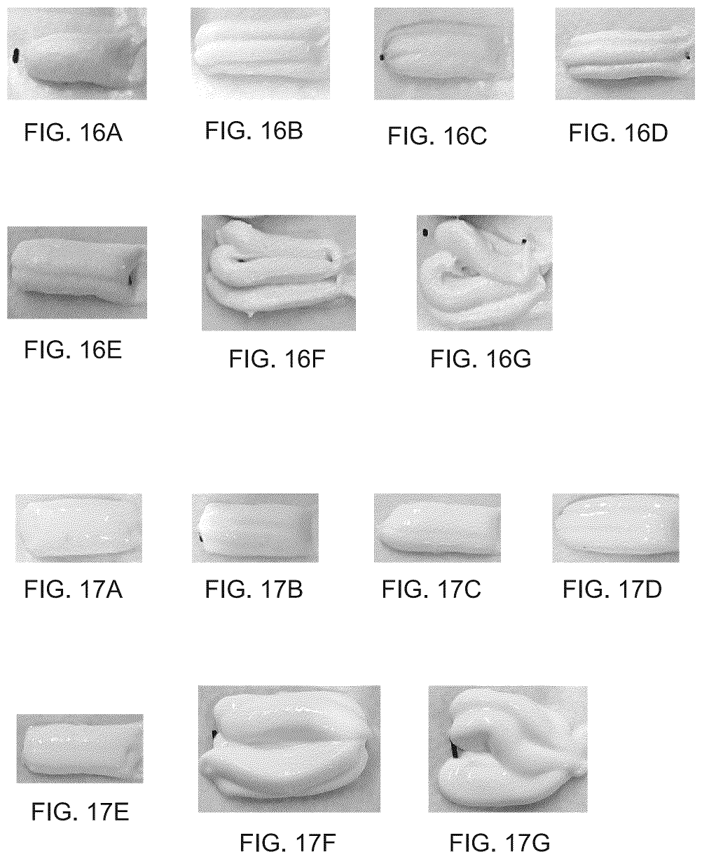

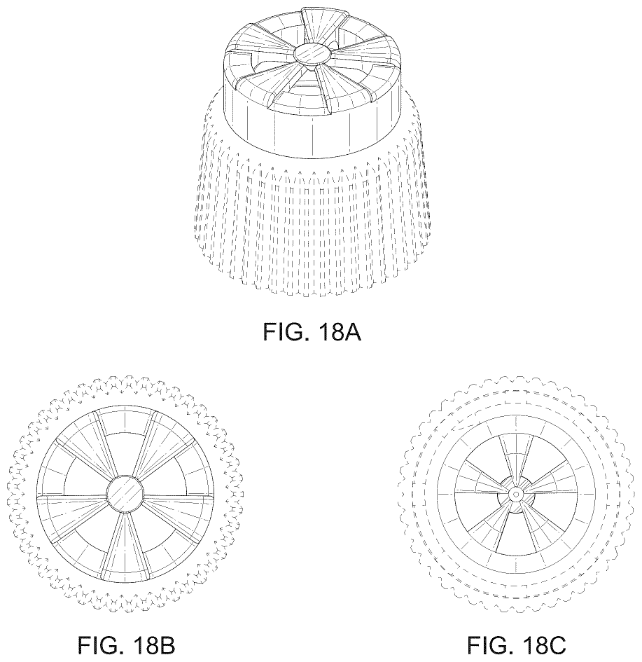

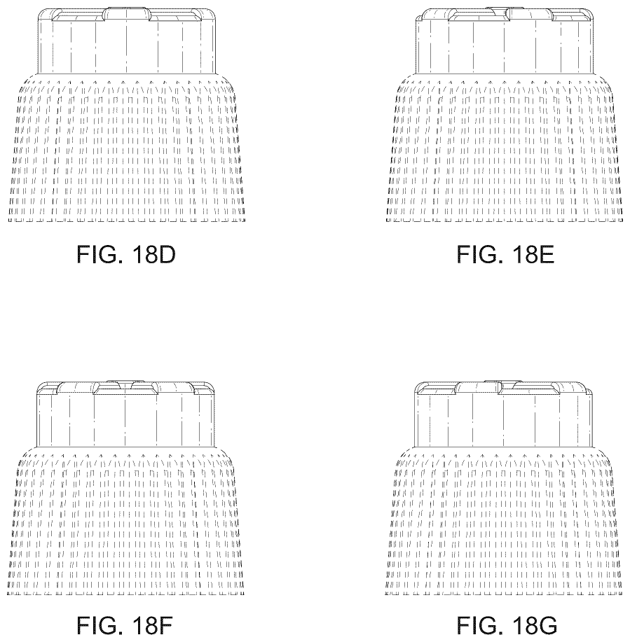

The nozzles shown in FIGS. 6 and 10-15 were tested with two toothpastes to evaluate the effect of nozzle shape on the weight of the resultant nurdle. The two toothpastes included Crest ProHealth Clean Mint (CPH) and Burt's Bees Purely White Zen Peppermint (Burt's). The extruded nurdles were each about 1″ in length. The Control nozzle and Ex. 8A-8F each have a circular orifice of 9.0 mm in diameter. The Control nozzle (FIG. 10) has an unobstructed orifice. Ex. 8A (FIG. 11) has five sector-shaped fins that are not connected to each other. Ex. 8B (FIG. 12) has five inclined sector-shaped fins that are not connected to each other. Ex. 8C (FIG. 13) and 8D (FIG. 14) are similar to Ex. 8A and 8B, respectively, except that the fins are coupled to a central hub. The fins of Ex. 8E (FIG. 6) are shaped similar to a curved fan blade shape. The fins of Ex. 8F (FIG. 15) have a propeller shape. The fins of both Ex. 8E and 8F are elevated distally from the orifice. The resulting nurdles are shown in FIGS. 15A-15G and 16A-16G. TABLE 22 provides the percent gravimetric increase for the Inventive Nozzles 8A-8F compared to the Control nozzle.

TABLE 22
Comparison of Nurdle Weight to Control for Varying Fin Configurations

| | Control | 8A | 8B | 8C | 8D | 8E | 8F |
|---|---|---|---|---|---|---|---|
| | (FIG. 10) | (FIG. 11) | (FIG. 12) | (FIG. 13) | (FIG. 14) | (FIG. 6) | (FIG. 15) |
| CPH | — | 12.4% | 19.1% | 20.6% | 15.6% | 104.0% | 172.9% |
| Burt's | — | 6.4% | 22.9% | 39.6% | 27.7% | 94.0% | 190.9% |

All of the Inventive Nozzles 8A-8F provided an increase in nurdle weight compared to the Control (FIG. 10). Ex. 8B, which had five inclined fins, provided a larger increase in weight for both CPH and Burt's compared to Ex. 8A, which has fins that are not inclined. However, when a central hub was present, Ex. 8C (0° incline) provided a larger increase in weight compared to Ex. 8D (inclined fins) for both CPH and Burt's. Ex. 8E and 8F both provided a significantly higher increase in weight compared to Ex. 8A-8D due at least in part to the off-axis extrusion provided by the nozzles. As can be seen in FIGS. 15F, 15G, 16F, and 16G, the nurdles produced by Ex. 8E and 8F may be less pleasing aesthetically for placement on a toothbrush head.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A nozzle for dispensing an oral care composition comprising:
an orifice having a central axis; and
fins partially occluding the orifice, wherein each of the fins has an upper surface and a lower surface.

2. The nozzle of claim 1, wherein a center of the orifice is occluded.

3. The nozzle of claim 1, further comprising a central hub, wherein the fins are coupled to the central hub.

4. The nozzle of claim 1, wherein the fins are not in contact with a central hub.

5. The nozzle of claim 1, wherein the upper surface of each of the fins is distal of the orifice.

6. The nozzle of claim 1, wherein the lower surface of each of the fins is proximal of the orifice.

7. The nozzle of claim 1, wherein the lower surface of each of the fins is distal of the orifice.

8. The nozzle of claim 1, further comprising an on-axis extrusion area and an off-axis extrusion area.

9. The nozzle of claim 1, further comprising a sidewall defining the orifice, wherein the sidewall comprises an inner wall, a rim, and an outer wall.

10. The nozzle of claim 9, wherein each of the fins further comprise an outer end that extends to the outer wall of the sidewall.

11. The nozzle of claim 9, wherein the lower surface of each of the fins extends from the inner surface of the sidewall.

12. The nozzle of claim 1, wherein the fins are inclined relative to the central axis of the orifice.

13. The nozzle of claim 1, wherein a distance between the lower surface of the fins and the orifice varies over a length of the fins.

14. The nozzle of claim 1, wherein a shape of the fins is a sector.

15. The nozzle of claim 1, wherein each of the fins comprises a longitudinal portion extending distally of the orifice, an axial portion extending over the orifice, and a transitional portion coupling the longitudinal portion and the axial portion.

16. An assembly comprising:
the nozzle of claim 1;
a tube; and
a cap configured to be coupled to the tube.

17. The assembly of claim 16, wherein the nozzle is integral with the cap or tube.

18. The assembly of claim 16, wherein the nozzle is coupled to the tube.

19. A method of dispensing an oral care composition comprising:
extruding the oral care composition through the nozzle of claim 1, wherein at least a portion of the oral care composition is extruded off-axis from the central axis of the orifice.

20. The method of claim 19, wherein an assembly comprises the nozzle and a tube containing the oral care composition, and extruding the oral care composition comprises applying pressure to the tube.
